(19) United States
(12) Patent Application Publication
(10) Pub. No.: US 2026/0279178 A1
(43) Pub. Date: Sep. 17, 2026

(54) CONTROL SYSTEM

(71) Applicant: NIPPON KAYAKU KABUSHIKI KAISHA, Tokyo (JP)

(72) Inventors: Nobuyuki SAEKI, Himeji-shi (JP); Koju IWASAKI, Himeji-shi (JP); Koichi SASAMOTO, Himeji-shi (JP); Takahiro HAGIHARA, Yokohama-shi (JP)

(73) Assignee: NIPPON KAYAKU KABUSHIKI KAISHA, Tokyo (JP)

(21) Appl. No.: 19/163,940

(22) PCT Filed: Mar. 13, 2024
(86) PCT No.: PCT/JP2024/009761

§ 371 Date: Sep. 10, 2025

(30) Foreign Application Priority Data
Mar. 14, 2023 (JP) 2023-039675

(51) Int. Cl. G08B 17/10; A62C 3/10; G01L 5/00; G08B 17/06; G08B 17/12; G08B 21/18

(52) U.S. Cl. CPC G08B 17/10; A62C 3/10; G01L 5/0028; G08B 17/06; G08B 17/12; G08B 21/182

(57) ABSTRACT

A control system includes a sensor that senses a state of an article having a possibility of ignition, the sensor being disposed separately from a detector of automatic fire alarm equipment in a space in which the detector is installed, an actuation apparatus that performs a process for actuating the detector, and a controller that causes the actuation apparatus to perform the process when the state of the article sensed by the sensor satisfies a condition determined in advance. The state of the article is at least one of a temperature of the article, a change in pressure of an internal pressure in the article, a change in intensity of infrared rays generated from the article, a change in intensity of ultraviolet rays generated from the article, and a strain of the article.

### TECHNICAL FIELD

The present invention relates to a control system for preventing occurrence of fire.

### BACKGROUND ART

In recent years, various types of devices equipped with batteries, such as smartphones, notebook personal computers (PC), drones, motorcycles, household storage batteries, and automobiles, have been in widespread use. With the widespread use of these devices, it has been recognized that there is a risk of fire caused by ignition and the like of a battery. In the case of a battery fire, first, the battery continues to generate heat for a long time period. When the temperature of the battery reaches a prescribed temperature, the battery undergoes thermal runaway and catches fire. The fire of the battery ignited by thermal runaway cannot be easily extinguished.

In a cargo compartment of an automobile carrier ship for transporting automobiles, several thousands of automobiles equipped with large-capacity batteries each having a possibility of ignition as described above are arranged at intervals of several tens of centimeters in four directions. Thus, when one of these automobiles catches fire resulting from a battery fire, the fire of this one automobile cannot be easily extinguished. Further, when one automobile catches fire, the fire instantaneously spreads to the surrounding automobiles. Therefore, it is extremely difficult to extinguish the fire started from the automobiles in the cargo compartment.

Thus, automobile carrier ships are conventionally equipped with automatic fire alarm equipment for detecting a fire. This automatic fire alarm equipment is mainly configured of: a detector that is actuated when it detects smoke, flames, heat, and the like generated by a fire; a receiver that notifies a crew member about the fire in response to the actuation of the detector as a trigger; and the like.

However, the automatic fire alarm equipment configured as described above provides a notification about the occurrence of fire after it occurs. Thus, even if the automatic fire alarm equipment detects smoke, flames, heat and the like after the flames appear, a fire spreading instantaneously as described above may be unable to be addressed.

In order to solve the above-described problem, for example, Japanese Patent Laying-Open No. 2005-312642 (PTL 1) discloses a fire detecting and alarming system for automobile carrier ships that includes: a plurality of sensor units each mainly including a fire-detection temperature sensor for detecting occurrence of fire based on information such as a surface temperature and the like of an automobile, the plurality of sensor units being dispersedly arranged on a ceiling portion of a cargo compartment; a plurality of control units each configured to receive a detection signal from the fire-detection temperature sensor and position information of each of the sensor units; and a central monitoring apparatus connected to the plurality of control units through a communication bus.

According to such a fire detecting and alarming system for automobile carrier ships, the fire-detection temperature sensor can quickly detect the sign of occurrence of fire at the stage before the fire occurs, and notify the central monitoring apparatus about the detection by a signal via each control unit. Thus, according to the fire detecting and alarming system disclosed in PTL 1, it can be expected that occurrence of fire can be prevented in advance.

### Citation List

### Patent Literature

PTL 1: Japanese Patent Laying-Open No. 2005-312642

### SUMMARY OF INVENTION

### Technical Problem

In order to adopt a fire detecting and alarming system for automobile carrier ships as disclosed in PTL 1, it is necessary to connect a control unit that receives a detection signal from a sensor unit and a central monitoring apparatus disposed in a steering room or the like through communication means. Further, the central monitoring apparatus needs to be optimized for the fire detecting information system. Thus, introducing the fire detecting and alarming system requires time and effort as well as cost.

The present invention has been made in view of the above-described points, and an object thereof is to provide a control system capable of reducing a risk of fire occurrence by using existing automatic fire alarm equipment.

### Solution to Problem

A control system according to the present invention includes: a sensor that senses a state of an article having a possibility of ignition, the sensor being disposed separately from a detector of automatic fire alarm equipment in a space in which the detector is installed; an actuation apparatus that performs a process for actuating the detector; and a controller that causes the actuation apparatus to perform the process when a temperature of the article sensed by the sensor satisfies a condition determined in advance. The state of the article is at least one of: a temperature of the article; a change in pressure of an internal pressure in the article; a change in intensity of infrared rays generated from the article; a change in intensity of ultraviolet rays generated from the article; and a strain of the article.

### Advantageous Effects of Invention

According to the present invention, it is possible to provide a control system capable of reducing the risk of fire occurrence by using existing automatic fire alarm equipment.

### BRIEF DESCRIPTION OF DRAWINGS

FIG. 1 is a diagram showing an arrangement of devices inside an automobile carrier ship adopting a control system and a fire sign alarm system.

FIG. 2 is a schematic front view of automobiles each equipped with the control system.

FIG. 3 is a schematic side view of the automobiles each equipped with the control system.

FIG. 4 is a diagram for illustrating a hardware configuration of each of devices constituting the control system.

FIG. 5 is a flowchart for illustrating a flow of a process performed in the control system.

FIG. 6 is a schematic diagram of a cargo compartment for illustrating a state in which an actuation apparatus is actuated.

FIG. 7 is a schematic diagram of the cargo compartment for illustrating a state in which an actuation apparatus according to a modification is actuated.

FIG. 8 is a schematic diagram of a cargo compartment for illustrating a state in which an actuation apparatus according to another modification is actuated.

FIG. 9 is a diagram for illustrating a hardware configuration of each of devices constituting a control system according to another embodiment.

FIG. 10 is a flowchart for illustrating a flow of a process performed in the control system.

FIG. 11 is a schematic diagram of a cargo compartment for illustrating a state in which an actuation apparatus according to another embodiment is actuated.

FIG. 12 is a schematic front view of automobiles to which a control system according to still another modification is applied.

FIG. 13 is a schematic front view of an actuation apparatus according to still another modification.

FIG. 14 is a schematic bottom view of the actuation apparatus according to still another modification.

FIG. 15 is a schematic front view of an actuation apparatus according to still another modification.

FIG. 16 is a schematic bottom view of the actuation apparatus according to still another modification.

FIG. 17 is a diagram for illustrating a hardware configuration of each of devices constituting a control system according to still another modification.

FIG. 18 is a schematic diagram of a cargo compartment for illustrating a state in which an actuation apparatus according to still another modification is actuated.

FIG. 19 is a diagram for illustrating a hardware configuration of each of devices constituting a control system according to another embodiment.

FIG. 20 is a schematic diagram of a cargo compartment for illustrating a state in which an actuation apparatus according to another embodiment is actuated.

### DESCRIPTION OF EMBODIMENTS

Hereinafter, embodiments of the present invention will be described in detail with reference to the accompanying drawings. Each of the embodiments described below provides an example in which the present invention is applied to a control system adopted in an automobile carrier ship in which a cargo compartment as an example of a space is loaded with automobiles each as an example of an article. In the embodiments described below, the same or common portions are denoted by the same reference characters in the drawings, and the description thereof will not be repeated.

### First Embodiment

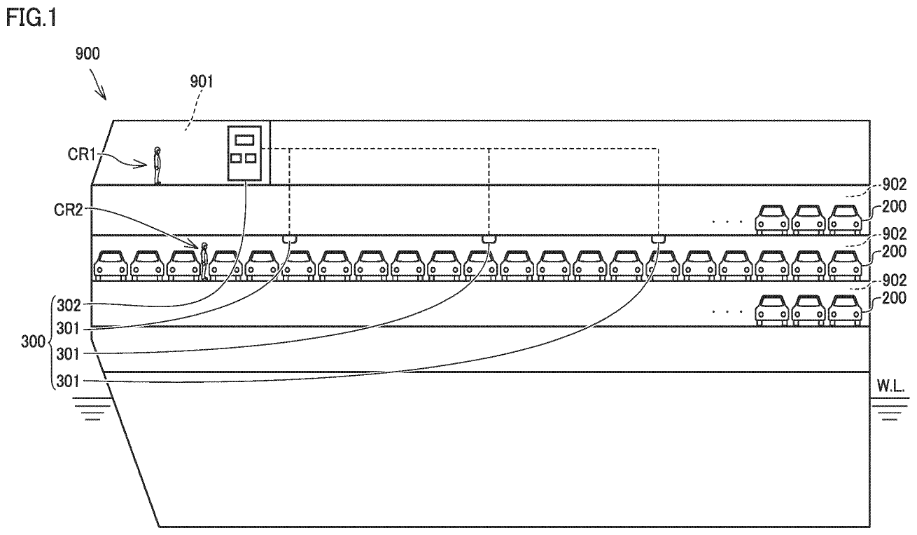

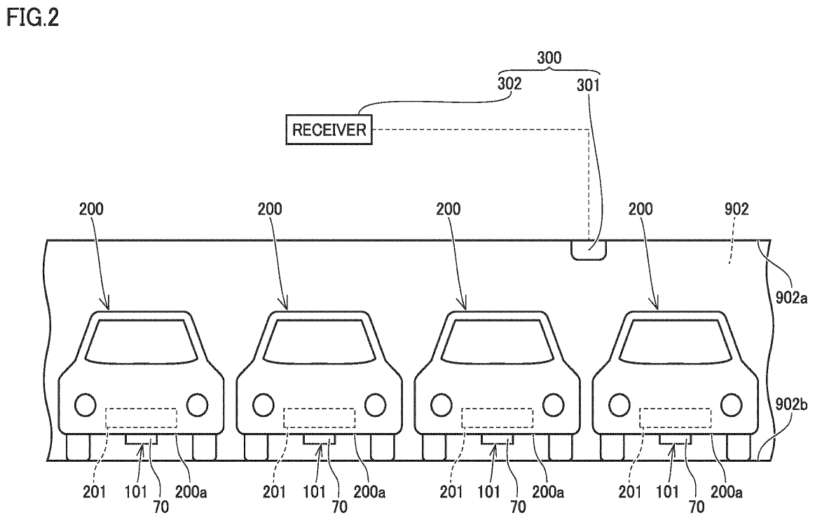

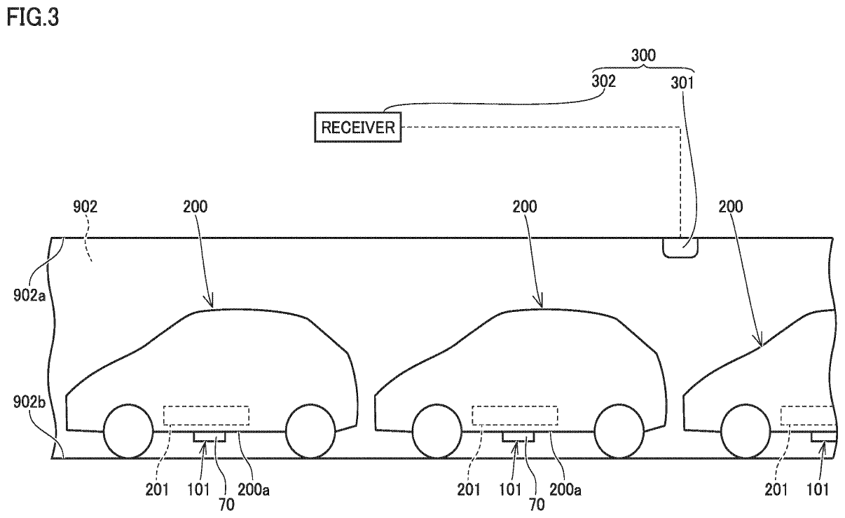

FIG. 1 is a diagram showing an arrangement of devices inside an automobile carrier ship adopting a control system and a fire sign alarm system according to the present embodiment. FIG. 2 is a schematic front view of automobiles each equipped with the control system according to the present embodiment. FIG. 3 is a schematic side view of the automobiles each equipped with the control system according to the present embodiment. Before describing a control system 101 and a fire sign alarm system according to the present embodiment, an outline of the configuration of an automobile carrier ship 900 adopting control system 101 will be first described with reference to FIGS. 1 to 3.

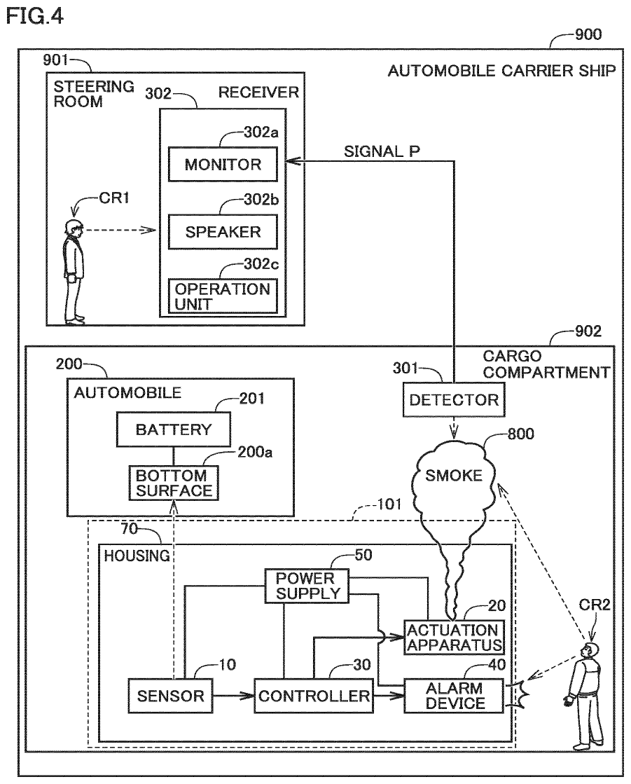

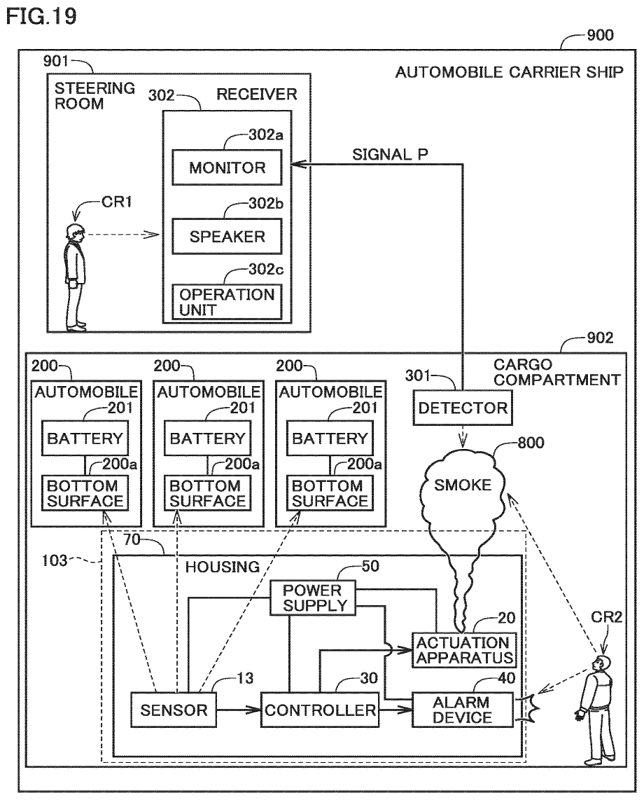

As shown in FIGS. 1 to 3, automobile carrier ship 900 mainly includes a steering room 901 and a cargo compartment 902. A plurality of crew members CRI are positioned in steering room 901 and perform steering of automobile carrier ship 900, monitoring of the inside of the ship, and the like. Note that FIG. 1 shows one of the plurality of crew members CR1 (the same also applies to FIGS. 4 and 19 described later).

Cargo compartment 902 is provided on each of a plurality of floors in automobile carrier ship 900. In each cargo compartment 902, a plurality of automobiles 200 are densely arranged at intervals of about 20 centimeters in four directions. A ceiling 902a of cargo compartment 902 is configured to be movable up and down according to the height of automobile 200. By way of example, the distance between a floor 902b and ceiling 902a of cargo compartment 902 (i.e., a ceiling height) is about 2 meters.

Further, inside cargo compartment 902, a crew member CR2 performs patrol, monitoring and the like for cargo compartment 902. FIG. 1 shows one of a plurality of crew members CR2 (the same also applies to FIGS. 4, 6 to 8, 11, and 18 to 20 described later).

Automobile carrier ship 900 is equipped with automatic fire alarm equipment 300 so as to enable quick fire extinction when fire occurs in automobile carrier ship 900. Automatic fire alarm equipment 300 includes a plurality of detectors 301 and a receiver 302.

The plurality of detectors 301 are installed on ceiling 902a of cargo compartment 902 to be located at a prescribed distance from each other. Thereby, when detector 301 is actuated, crew member CR1 can recognize an approximate position of occurrence of fire based on a predetermined signal P (see FIG. 4) transmitted from the actuated detector 301 to receiver 302.

In the present example, each detector 301 is what is called a photoelectric spot-type detector that detects smoke. The photoelectric spot-type detector incorporates a light emitting unit and a light receiving unit. The light emitted from the light emitting unit collides with smoke particles having flowed into the detector and is then irregularly reflected. The irregularly reflected light is then detected by the light receiving unit. The light receiving unit detects light and thereby the detector is actuated.

The detector for detecting smoke is not limited to the photoelectric spot-type detector. The detector for detecting smoke may be a projected beam-type detector and the like.

When detector 301 is actuated, receiver 302 receives signal P transmitted from detector 301 and thereby notifies crew member CR1 and the like about fire. Receiver 302 is typically disposed in steering room 901. Receiver 302 mainly includes: a monitor 302a used for display of an alarm, display of the position of the actuated detector 301, and the like; a speaker 302b for providing a notification about at least an alarm via voice; and an operation unit 302c (see FIG. 4 described later).

Detector 301 and receiver 302 are connected to each other through wires (see dashed lines in FIG. 1). Signal P issued by actuation of detector 301 that has detected smoke is transmitted to receiver 302 through the wires. When receiver 302 receives signal P issued by detector 301, crew member CR1 in steering room 901 is notified about fire.

As shown in FIGS. 2 and 3, a battery 201 for supplying electric power to a motor as a drive source is incorporated in each of automobiles 200 arranged in cargo compartment 902. As battery 201, for example, a lithium ion battery is suitably used. FIGS. 1 to 3 and the like each show a private automobile as automobile 200, but automobile 200 is not limited thereto. Automobile 200 should only be an automobile including an internal combustion engine as a drive source, a motor as a drive source, or a combination of an internal combustion engine and a motor as a drive source, and also including wheels. For example, automobile 200 may be a motorcycle, a bus, a truck, or the like.

Battery 201 is an article having a possibility of ignition. Specifically, when battery 201 suffers deterioration or the like, the electrolyte inside battery 201 is oxidized to generate combustible gas. When some impact is applied to battery 201 during generation of combustible gas, battery 201 may catch fire. If there is a problem in the manufacturing process of battery 201, battery 201 may catch fire. Due to overcharging, battery 201 may catch fire.

An automobile equipped with a battery may catch fire even during power-off, which is a phenomenon referred to as a “tracking phenomenon”. Specifically, even during power-off, an electrical leakage occurs when liquid such as moisture and foreign matters such as dust coexist in a wire connected to the battery. Thereby, the battery may catch fire.

FIG. 4 is a diagram for illustrating a hardware configuration of each of devices constituting the control system shown in FIG. 1. The configuration of control system 101 will be described with reference to FIGS. 2 to 4.

As shown in FIGS. 2 to 4, control system 101 includes a sensor 10, an actuation apparatus 20, a controller 30, an alarm device 40, and a power supply 50. In control system 101, a housing 70 incorporates sensor 10, actuation apparatus 20, controller 30, alarm device 40, and power supply 50. In other words, in the present embodiment, control system 101 is configured as a single discrete apparatus.

Sensor 10 is provided separately from detector 301 of automatic fire alarm equipment 300. In the present embodiment, sensor 10 senses the temperature of automobile 200 as the state of automobile 200. Specifically, sensor 10 senses the surface temperature of a bottom surface 200a of automobile 200. More specifically, sensor 10 senses the surface temperature of a portion of bottom surface 200a that is located in the vicinity of (more specifically, directly below) battery 201.

A temperature sensor is used as sensor 10. There are two types of temperature sensors including: a contact-type temperature sensor and a contactless-type temperature sensor. Examples of the contact-type temperature sensor include a thermocouple, a platinum resistance thermometer, a thermistor thermometer, a bimetal-type thermometer, a liquid-filled thermometer, a mercury thermometer, and the like. The contactless-type temperature sensor measures a temperature by measuring infrared rays emitted from an object. As the contactless-type temperature sensor, for example, a thermal-type (non-cooling type) or quantum-type (cooling-type) temperature sensor is used.

In the present embodiment, a contactless-type temperature sensor is used as sensor 10. The contactless-type temperature sensor can sense the surface temperature of bottom surface 200a irrespective of the shape of bottom surface 200a.

A plurality of sensors 10 are preferably installed from the viewpoint of partially or entirely providing redundancy. Thereby, even if a failure occurs in one of sensors 10, other sensors 10 can function as a substitute therefor.

When battery 201 generates heat, heat is transmitted from battery 201 to bottom surface 200a. Thus, sensor 10 senses the surface temperature of bottom surface 200a to thereby enable detection of abnormal heat generation in battery 201.

Actuation apparatus 20 performs a process for actuating detector 301. In this case, the details of the above-mentioned process differ depending on the type of detector 301 installed in cargo compartment 902, and, in the present embodiment, actuation apparatus 20 should only emit smoke or heat. In the present example, since detector 301 serves to detect smoke, actuation apparatus 20 emits smoke as the above-described process. Thus, in the present embodiment, actuation apparatus 20 includes a smoke canister. The smoke canister may contain a smoke generating agent composed of gunpowder and the like, or may contain compressed gas composed of a powdery fire extinguishing agent, nanozeolites or the like.

Every predetermined control cycle T (for example, every one second), controller 30 acquires the temperature information indicating the temperature sensed by sensor 10 from this sensor 10. When the temperature of automobile 200 sensed by sensor 10 satisfies a predetermined condition, controller 30 causes actuation apparatus 20 to perform a warning process. Specifically, when the surface temperature of bottom surface 200a of automobile 200 that is sensed by sensor 10 becomes equal to or higher than a set temperature V1, controller 30 causes actuation apparatus 20 to generate smoke.

In the case of abnormal heat generation inside battery 201, when the temperature of battery 201 rises to a prescribed temperature gradually from the temperature at which no abnormality occurs, then, battery 201 undergoes thermal runaway and catches fire. Thus, a set temperature V1 is set in advance that is the surface temperature of bottom surface 200a at which battery 201 reaches a prescribed temperature lower than the ignition temperature of battery 201. Thereby, controller 30 can cause actuation apparatus 20 to generate smoke at a stage before ignition of battery 201. In the present example, set temperature V1 is set at 80° C. Set temperature V1 is not limited to 80° C. but can be set as appropriate.

Controller 30 includes, as main components, a central processing unit (CPU) that executes a program, a read only memory (ROM), a random access memory (RAM), and a flash memory. The CPU executes the program to implement various processes in the present embodiment.

Specifically, the CPU (a computing unit) performs a prescribed computation based on the temperature information acquired from sensor 10. The ROM and the flash memory store data in a nonvolatile manner. The flash memory stores the program. The RAM stores, in a volatile manner, data generated by execution of the program by the CPU. The components constituting controller 30 are connected to each other through a data bus.

Alarm device 40 issues an alarm to the surroundings of housing 70 by sound and/or light. In the present embodiment, a buzzer that continuously emits sound and light (typically, a flash of light) is used as alarm device 40. Without being limited to the above, alarm device 40 should only be configured to issue an alarm to the surroundings of housing 70 by at least one of sound and light.

Power supply 50 incorporated in housing 70 supplies electric power to actuation apparatus 20, controller 30, and alarm device 40. In the present example, power supply 50 is a primary battery. Primary batteries are inexpensive and easily available throughout the world. Note that power supply 50 may be any one of a primary battery, a secondary battery, or a power supply that is supplied from a power supply incorporated in a ship through a universal serial bus (USB) cable or via an alternating-current/direct-current (AC/DC) converter that converts an AC voltage into a DC voltage.

Housing 70 has a substantially rectangular parallelepiped shape. Housing 70 is disposed in contact with a portion of bottom surface 200a of automobile 200 that is located in the vicinity of battery 201. Specifically, housing 70 has a magnet (not shown) in a portion of the outer surface of housing 70 that faces bottom surface 200a. Housing 70 is attached to bottom surface 200a by the magnetic force of the magnet.

Note that the shape of housing 70 is not limited to a substantially rectangular parallelepiped shape but is changeable as appropriate. A method of attaching housing 70 to bottom surface 200a is not limited to the method utilizing the magnetic force of the magnet. For example, housing 70 may be attached to bottom surface 200a by adhesive force of an adhesive provided on a portion of the outer surface of housing 70 that faces bottom surface 200a.

After loading of automobiles 200 on automobile carrier ship 900 is completed, automobiles 200 each are fixed in position by a lasher such that automobiles 200 do not move during transportation on the sea. Housing 70 is attached to bottom surface 200a typically simultaneously with attachment of the lasher to each automobile 200. Housing 70 is removed from bottom surface 200a before automobiles 200 are unloaded from automobile carrier ship 900. Housing 70 is removed from bottom surface 200a simultaneously with release of the position fixing of automobile 200 by the lasher.

By the fire sign alarm system including control system 101 configured as described above and automatic fire alarm equipment 300 having detector 301 and receiver 302, it is possible to provide a notification about a sign of fire caused from automobile 200 disposed in cargo compartment 902 in which detector 301 is installed. This will be described later in detail.

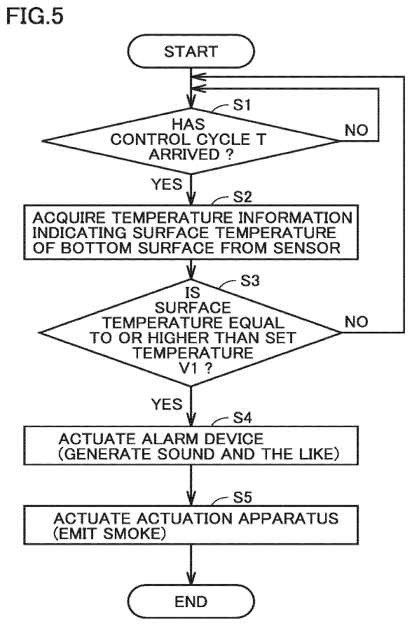

FIG. 5 is a flowchart for illustrating a flow of a process performed in the control system shown in FIG. 4. The process performed in control system 101 will be hereinafter described with reference to FIG. 5.

In the present example, the following process by control system 101 is started after a prescribed time period (for example, 30 minutes) has elapsed since completion of loading of automobiles 200 on automobile carrier ship 900. Specifically, the following process is performed after a prescribed time period has elapsed since attachment of housing 70 to bottom surface 200a of automobile 200. More specifically, the following process is performed after a prescribed time period has elapsed since a user turned on a switch (for example, a power supply switch or a switch for starting an operation) provided in housing 70.

The process is delayed by a prescribed time period for the following reason. Immediately after completion of loading of automobiles 200 on automobile carrier ship 900, battery 201 has generated considerable heat due to the driving operation of each automobile 200 for the loading. It is necessary to prevent control system 101 from performing the following process based on the surface temperature of bottom surface 200a that has been raised by this heat generation. Thus, the process is delayed by a prescribed time period as described above. From the viewpoint of preventing an erroneous operation, the switch is preferably provided so as not to protrude from the outer surface of housing 70.

As shown in FIG. 5, in step S1, controller 30 determines whether or not a predetermined control cycle T has arrived. When it is determined that control cycle T has arrived (YES in step S1), controller 30 proceeds the process to step S2. When it is determined that control cycle T has not arrived (NO in step S1), controller 30 proceeds the process to step S1.

In step S2, from sensor 10, controller 30 acquires temperature information indicating the surface temperature of bottom surface 200a of automobile 200 that has been sensed by sensor 10. After step S2, controller 30 determines in step S3 whether or not the surface temperature of bottom surface 200a of automobile 200 is equal to or higher than set temperature V1 as a first temperature.

When it is determined that the surface temperature of bottom surface 200a is equal to or higher than set temperature V1 (YES in step S3), then in step S4, controller 30 actuates alarm device 40 to continuously generate sound and light (typically, a flash of light). Thereby, a notification about occurrence of an abnormality is provided to the surroundings. After a prescribed time period has elapsed since the start of the actuation of alarm device 40, in step S5, actuation apparatus 20 is actuated to emit smoke.

When it is determined that the surface temperature of bottom surface 200a is lower than set temperature V1 (NO in step S3), controller 30 proceeds the process to step S1. Controller 30 may perform the process in step S5 before the process in step S4. Alternatively, controller 30 may simultaneously perform the process in step S4 and the process in step S5.

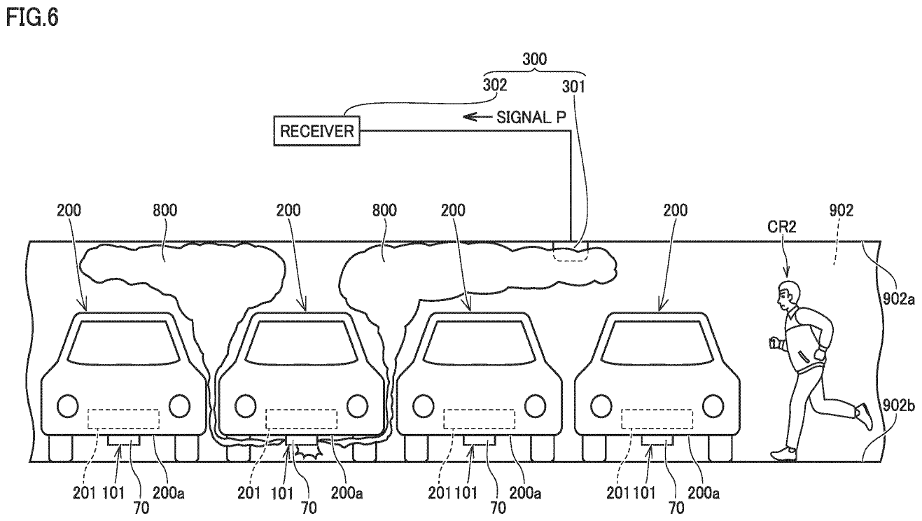

FIG. 6 is a schematic diagram of a cargo compartment for illustrating the state in which the actuation apparatus shown in FIG. 4 is actuated. Referring to FIGS. 4 and 6, the following describes a process performed by control system 101 and a process performed by the fire sign alarm system including control system 101.

As described above, controller 30 actuates actuation apparatus 20, so that smoke 800 is emitted from the smoke canister included in actuation apparatus 20 as shown in FIGS. 4 and 6. Smoke 800 is diffused around housing 70. The diffused smoke 800 is detected by detector 301 installed on ceiling 902a. The diffused smoke 800 is typically detected by detector 301 installed on ceiling 902a in the vicinity of automobile 200 to which control system 101 equipped with the actuated actuation apparatus 20 is attached.

When detector 301 detects smoke 800, detector 301 is actuated. When detector 301 is actuated, the actuated detector 301 transmits signal P to receiver 302. Receiver 302 having received signal P causes monitor 302a to display an alarm or causes speaker 302b to issue an alarm. This allows crew member CR1 positioned in steering room 901 to recognize that battery 201 is in an abnormal temperature state. In other words, crew member CR1 can recognize that there is a sign of fire caused from battery 201.

Thus, according to control system 101, automatic fire alarm equipment 300 can be actuated before ignition of battery 201. This allows crew members CR1, CR2 and the like to promptly take a predetermined appropriate action before ignition of battery 201. As a result, according to control system 101, the risk of occurrence of fire resulting from automobile 200 in cargo compartment 902 can be reduced.

By using automatic fire alarm equipment 300 that is existing equipment in automobile carrier ship 900, control system 101 provides a notification about a sign of fire resulting from automobile 200. Thus, the only operation necessary to introduce control system 101 is substantially to attach control system 101 to automobile 200.

As described above, according to control system 101, the risk of occurrence of fire can be reduced by using the existing automatic fire alarm equipment. Further, control system 101 can be easily introduced into automobile carrier ship 900.

In the case where control system 101 is used, smoke 800 produced by actuation apparatus 20 is emitted from below automobile 200 equipped with battery 201 having an abnormal temperature. Thereby, crew member CR2 positioned in cargo compartment 902 visually observes the emitted smoke and thereby can instantaneously specify the position of automobile 200 equipped with control system 101 that has emitted smoke 800. This allows crew member CR2 and the like to promptly take an appropriate action before ignition of battery 201. Therefore, the risk of occurrence of fire resulting from automobile 200 in cargo compartment 902 can be further reduced.

Further, in control system 101, alarm device 40 continuously emits sound and light below the above-mentioned automobile 200 simultaneously with the emission of smoke 800 by actuation apparatus 20. Thus, crew member CR2 can instantaneously specify the position of automobile 200 also by the sound and light emitted by alarm device 40. Therefore, the risk of occurrence of fire resulting from automobile 200 in cargo compartment 902 can be still further reduced.

Further, in the present embodiment, the arrangement of housing 70 is changeable as appropriate within a range in which occurrence of an abnormality in automobile 200 can be sensed by sensor 10. For example, housing 70 can be disposed in contact with bottom surface 200a of automobile 200, as described above. In this way, according to the present example, sensor 10 can be installed at a position where an abnormality in automobile 200 can be reliably sensed. In other words, according to the present example, the position of sensor 10 can be changed as appropriate such that a target to be sensed (an article having a possibility of ignition) is not located in the blind spot of sensor 10. Therefore, the present example makes it possible to prevent, in advance, a failure in detection of the occurrence (appearance) of an abnormality by sensor 10 and a delay in finding an abnormality due to such a failure in detection. According to the present example, an initial action can be immediately taken against an abnormality in automobile 200.

In the example described above in the present embodiment, controller 30 causes actuation apparatus 20 to perform the process when the surface temperature of bottom surface 200a of automobile 200 sensed by sensor 10 becomes equal to or higher than set temperature V1 (80° C. in the present example). However, the condition to be satisfied by the surface temperature for controller 30 to cause actuation apparatus 20 to perform the process is not limited thereto. For example, the condition may be that the amount of change in the surface temperature per unit time is equal to or greater than a predetermined threshold value.

Further, in the example described above in the present embodiment, control system 101 is configured to be able to cause actuation apparatus 20 to generate smoke at a stage before ignition of battery 201 provided inside automobile 200. However, control system 101 may be configured to be able to cause actuation apparatus 20 to generate smoke at a stage immediately after ignition of battery 201. In other words, control system 101 may be configured such that, when fire occurs inside an article having a possibility of ignition, control system 101 is able to cause actuation apparatus 20 to generate smoke at a stage before combustion occurs on the outer surface of the article due to this fire. Also in this case, adopting control system 101 allows the risk of occurrence of fire to be reduced by using the existing automatic fire alarm equipment.

In the example described above in the present embodiment, control system 101 is adopted for automobile carrier ship 900 in which automobiles 200 each including battery 201 are arranged in cargo compartment 902 equipped with detector 301 of automatic fire alarm equipment 300. Without being limited to the above, control system 101 can naturally be adopted also in cases other than an automobile carrier ship in which such automobiles are arranged in a cargo compartment.

As one example, control system 101 may be adopted in a cargo warehouse including a cargo compartment (a space) in which a detector of automatic fire alarm equipment is installed and in which large-capacity battery systems (articles) such as household storage batteries are disposed.

As another example, control system 101 may be adopted in an aircraft including a cargo compartment (a space) in which a detector of automatic fire alarm equipment is installed and in which containers (articles) each accommodating a spray can and the like are disposed.

As still another example, control system 101 may be adopted in a cargo train including a container (a space) in which a detector of automatic fire alarm equipment is installed and in which smartphones (articles) each incorporating a battery are disposed.

As still another example, control system 101 may be adopted in a ship and the like including a cargo compartment (a space) in which a detector of automatic fire alarm equipment is installed and in which unmanned or manned drones (articles) each driven by a battery are disposed.

As described above, the articles each having a possibility of ignition may be various types of cargoes transported by a ship, an aircraft, and a cargo train, or various types of cargoes placed in a warehouse.

Further, the articles each having a possibility of ignition may be not only the above-mentioned cargoes but also equipment (a machine) provided in a space in which a detector of automatic fire alarm equipment is installed. For example, an article having a possibility of ignition may be an engine, a power generator, a cleaner, and the like provided in an engine room of a ship.

### Modifications

### First Modification

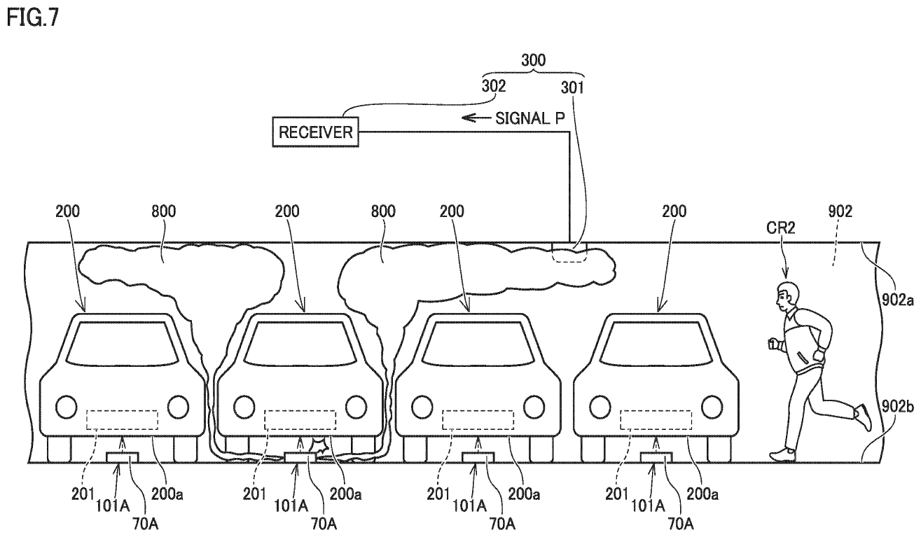

FIG. 7 is a schematic diagram of a cargo compartment for illustrating the state in which an actuation apparatus according to the first modification is actuated. Hereinafter, a control system 101A according to the first modification of the first embodiment will be described with reference to FIG. 7.

As shown in FIG. 7, control system 101A according to the present modification includes a housing 70A instead of housing 70. Control system 101A is different from control system 101 in the arrangement of housing 70A.

Specifically, in control system 101, housing 70 is disposed in contact with a portion of bottom surface 200a of automobile 200 that is located in the vicinity of (more specifically, directly below) battery 201 (see FIG. 2 and the like). On the other hand, in control system 101A, housing 70A is disposed in the vicinity of automobile 200 without being in contact with automobile 200. More specifically, in control system 101A, housing 70A is placed on a portion of floor 902b of cargo compartment 902 that faces a portion of bottom surface 200a of automobile 200 that is located directly below battery 201.

Control system 101A configured as described above also achieves an effect similar to the effect described in the above embodiment. Therefore, according to control system 101A, the risk of occurrence of fire can be reduced by using existing automatic fire alarm equipment.

### Second Modification

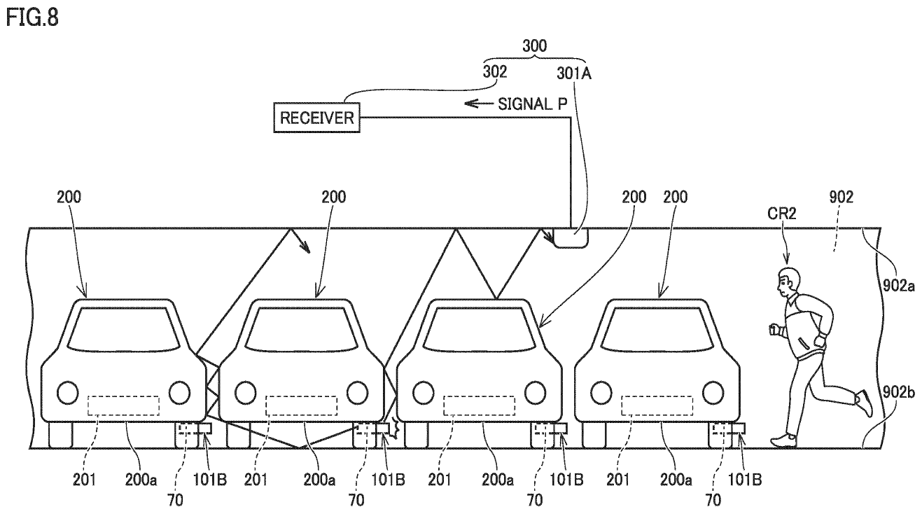

In a configuration which will be described in the present modification, the automatic fire alarm equipment includes at least a detector configured to detect ultraviolet rays instead of detector 301 for detecting smoke. FIG. 8 is a schematic diagram of a cargo compartment for illustrating the state in which an actuation apparatus according to the second modification is actuated. Hereinafter, a control system 101B according to the second modification of the first embodiment will be described with reference to FIG. 8.

As shown in FIG. 8, in the present modification, automatic fire alarm equipment 300 includes a plurality of detectors 301A and receiver 302. Specifically, instead of detector 301, detector 301A is provided in cargo compartment 902.

Detector 301A is an ultraviolet spot-type detector that detects the intensity of ultraviolet rays and is actuated when the amount of change in intensity of the ultraviolet rays becomes equal to or greater than an amount of change W1 determined in advance. Thus, the present modification adopts detector 301A configured to detect the intensity of ultraviolet rays, which is different from the above-described configuration adopting detector 301 configured to detect smoke 800. Accordingly, the configuration of the actuation apparatus in control system 101B is also different from the configuration of actuation apparatus 20 in control system 101.

More specifically, in control system 101 according to the above-described embodiment, actuation apparatus 20 emits smoke 800 as a process for actuating detector 301 (see FIG. 6 and the like), whereas in control system 101B according to the present modification, the actuation apparatus generates ultraviolet rays as a process for actuating detector 301A. More specifically, in the present modification, an ultraviolet light emitting diode (LED) light that emits light including ultraviolet rays is used as an actuation apparatus. Specifically, light including ultraviolet rays is emitted from the ultraviolet LED light such that the amount of change in the intensity of ultraviolet rays detected by detector 301A becomes equal to or greater than the amount of change W1 as a second amount of change determined in advance.

According to control system 101B, controller 30 causes the actuation apparatus to emit ultraviolet rays. Since the ultraviolet rays tend to go straight, the emitted ultraviolet rays enter the detection range of detector 301A while being repeatedly reflected between the surrounding objects. Thereby, the amount of change in the intensity of the ultraviolet rays detected by detector 301A becomes equal to or greater than the amount of change W1. As a result, detector 301A can be actuated. In this way, in the present modification, detector 301A can be actuated by the actuation apparatus in the state in which no flame occurs.

Control system 101B configured as described above also achieves an effect similar to the effect described in the above embodiment. Therefore, according to control system 101B, the risk of occurrence of fire can be reduced by using the existing automatic fire alarm equipment.

Control system 101B according to the present modification is different in arrangement of housing 70 from control system 101 according to the above-described embodiment. Specifically, in control system 101B, housing 70 is disposed to partially protrude outward from the peripheral edge of bottom surface 200a of automobile 200. Thereby, detector 301A can more reliably detect the ultraviolet rays emitted from the actuation apparatus, as compared with the case where housing 70 is disposed in contact with a portion of bottom surface 200a that is located directly below battery 201.

In the configuration described above as an example, an ultraviolet spot-type detector is installed as detector 301A on ceiling 902a. However, the present invention is not limited thereto. As detector 301A, an infrared spot-type detector may be used that detects the intensity of infrared rays and is actuated when the amount of change in the intensity of infrared rays becomes equal to or greater than an amount of change W2 as the second amount of change determined in advance. In this case, the actuation apparatus should only be configured to emit infrared rays instead of ultraviolet rays. Specifically, light including infrared rays is emitted from an infrared LED light or a laser diode such that the amount of change in the intensity of infrared rays detected by detector 301A becomes equal to or greater than the amount of change W2 determined in advance. Even in such a configuration, the actuation apparatus can actuate detector 301A in the state in which no flame occurs.

### Third Modification

In a configuration which will be described in the present modification, a sensor included in a control system senses the internal pressure in automobile 200 instead of sensing the temperature of automobile 200 as the state of automobile 200. In such a configuration, a known pressure sensor can be used as the sensor.

When battery 201 generates heat, the heat of battery 201 warms the air inside automobile 200. When the air is warmed, the internal pressure in automobile 200 rises. In the present modification, the sensor senses a rise in internal pressure in automobile 200 and thereby can sense abnormal heat generation in battery 201.

The controller according to the present modification determines whether or not the amount of change in pressure of the internal pressure in automobile 200 is equal to or greater than an amount of change W3 as the first amount of change determined in advance. When it is determined that the amount of change in pressure of the internal pressure in automobile 200 is equal to or greater than the amount of change W3, the controller actuates alarm device 40 to continuously generate sound and light in the same manner as in the above-described embodiment. Further, the controller actuates actuation apparatus 20 at the above-described timing (after a prescribed time period has elapsed since the start of the actuation of alarm device 40) to thereby cause actuation apparatus 20 to emit smoke.

The control system configured as described above also achieves an effect similar to the effect described in the above embodiment. Therefore, according to the control system of the present modification, the risk of occurrence of fire can be reduced by using the existing automatic fire alarm equipment.

### Fourth Modification

In a configuration which will be described in the present modification, a sensor included in the control system senses infrared rays generated from automobile 200 instead of sensing the temperature of automobile 200 as the state of automobile 200. In such a configuration, a known infrared sensor can be used as the sensor.

When battery 201 generates heat, the heat is transmitted from battery 201 to a body of automobile 200, so that bottom surface 200a defining a part of the body is heated. Bottom surface 200a is heated to increase the intensity of the infrared rays emitted from bottom surface 200a. In the present modification, the sensor senses the intensity of the infrared rays and thereby can sense abnormal heat generation in battery 201.

The controller according to the present modification determines whether or not the amount of change in intensity of the infrared rays generated from automobile 200 is equal to or greater than an amount of change W4 as the first amount of change determined in advance. When it is determined that the amount of change in intensity of the infrared rays generated from automobile 200 is equal to or greater than the amount of change W4, alarm device 40 is actuated to continuously generate sound and light in the same manner as in the above-described embodiment. Further, the controller actuates actuation apparatus 20 at the above-described timing to cause actuation apparatus 20 to emit smoke.

The control system configured as described above also achieves an effect similar to the effect described in the above embodiment. Therefore, according to the control system of the present modification, the risk of occurrence of fire can be reduced by using the existing automatic fire alarm equipment.

In the above description, a sensor that senses infrared rays has been described as an example. However, the present invention is not limited thereto. A sensor that senses the intensity of the ultraviolet rays generated from automobile 200 may also be used. In this case, the controller determines whether or not the amount of change in the intensity of the ultraviolet rays generated from automobile 200 is equal to or greater than an amount of change W5 as the first amount of change determined in advance. When it is determined that the amount of change in the intensity of the ultraviolet rays generated from automobile 200 is equal to or greater than the amount of change W5, alarm device 40 is actuated to continuously generate sound and light in the same manner as described above. Further, the controller actuates actuation apparatus 20 at the above-described timing to causes actuation apparatus 20 to emit smoke. Even such a configuration achieves an effect similar to the effect described in the above embodiment.

Further, as the sensor, a combination of a portion for sensing infrared rays and a portion for sensing ultraviolet rays may be used. In this case, these portions for sensing infrared rays and ultraviolet rays complement each other to enable detection of the state of automobile 200. This can prevent a failure in detection of the change in the state of automobile 200.

### Fifth Modification

In a configuration which will be described in the present modification, a sensor included in the control system senses a strain of automobile 200 instead of sensing the temperature of automobile 200 as the state of automobile 200. Specifically, the sensor according to the present modification senses a strain of bottom surface 200a of automobile 200. In such a configuration, a known strain sensor can be used as the sensor.

When battery 201 generates heat, heat is transmitted from battery 201 to a body of automobile 200 to thereby cause a thermal strain in bottom surface 200a defining a part of the body. In the present modification, the strain in bottom surface 200a that increases due to the heat generated in battery 201 is sensed by the sensor, and thereby, abnormal heat generation in battery 201 can be sensed.

The controller according to the present modification determines whether or not the amount of change in strain of automobile 200 is equal to or greater than an amount of change W6 as the first amount of change determined in advance. When it is determined that the amount of change in strain of automobile 200 is equal to or greater than the amount of change W6, alarm device 40 is actuated to continuously generate sound and light in the same manner as in the above-described embodiment. Further, the controller actuates actuation apparatus 20 at the above-described timing to cause actuation apparatus 20 to emit smoke.

The control system configured as described above also achieves an effect similar to the effect described in the above embodiment. Therefore, according to the control system of the present modification, the risk of occurrence of fire can be reduced by using the existing automatic fire alarm equipment.

### Sixth Modification

In a configuration which will be described in the present modification, a sensor included in the control system senses the outer appearance of automobile 200 as image data instead of sensing the temperature of automobile 200 as the state of automobile 200. In this case, the outer appearance of automobile 200 means not only the outer appearance of automobile 200 itself but also the outer appearance of automobile 200 including the space therearound.

The sensor according to the present modification senses the outer appearances of bottom surface 200a of automobile 200 and the space therearound as image data. As the sensor having such a configuration, a known camera can be used.

Further, in the control system according to the present modification, housing 70A is placed on a portion of floor 902b of cargo compartment 902 that faces a portion of bottom surface 200a of automobile 200 that is located directly below battery 201, similarly to control system 101A according to the first modification of the above-described first embodiment.

When battery 201 generates heat and thereby emits smoke, the smoke spreads in the space around bottom surface 200a. The controller according to the present modification sets, as a predetermined condition, that smoke appears in an image represented by the image data. The controller determines whether or not smoke appears in the image. When it is determined that smoke appears, the controller actuates alarm device 40 to continuously generate sound and light, as in the above-described embodiment. Further, the controller actuates actuation apparatus 20 at the above-described timing to thereby cause actuation apparatus 20 to emit smoke.

The control system configured as described above also achieves an effect similar to the effect described in the above embodiment. Therefore, according to the control system of the present modification, the risk of occurrence of fire can be reduced by using the existing automatic fire alarm equipment.

In the above description, a sensor that senses the outer appearances of bottom surface 200a of automobile 200 and the space therearound as image data has been described as an example. However, the present invention is not limited thereto. Examples of the sensor used herein may be a sensor that senses, as image data, the outer appearances of the top surface of automobile 200 and the space therearound.

Further, the sensor used herein may be a combination of a portion for sensing the outer appearance of automobile 200 as image data and a portion for sensing infrared rays and/or a portion for sensing ultraviolet rays, as described above. In this case, these portions complement each other to enable detection of the state of automobile 200. This can prevent a failure in detection of the change in the state of automobile 200.

### Second Embodiment

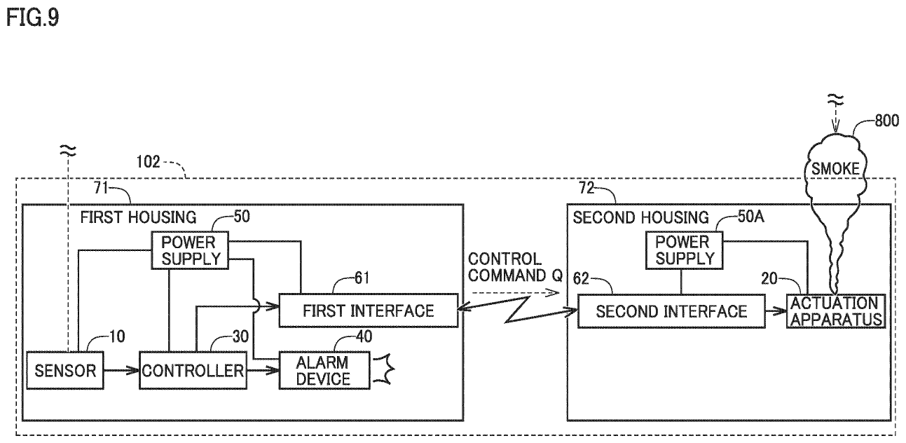

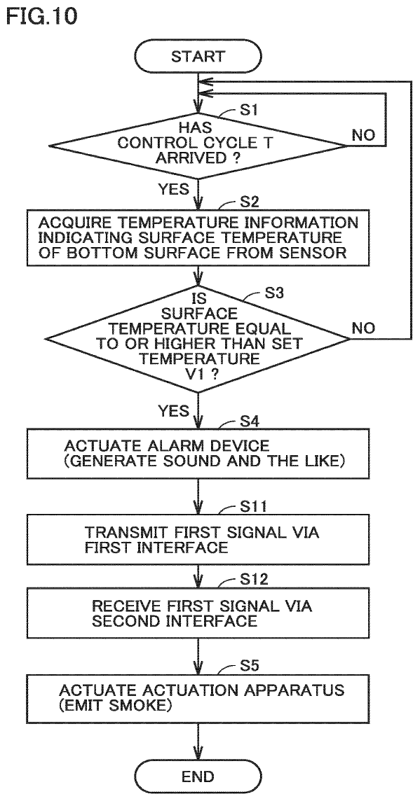

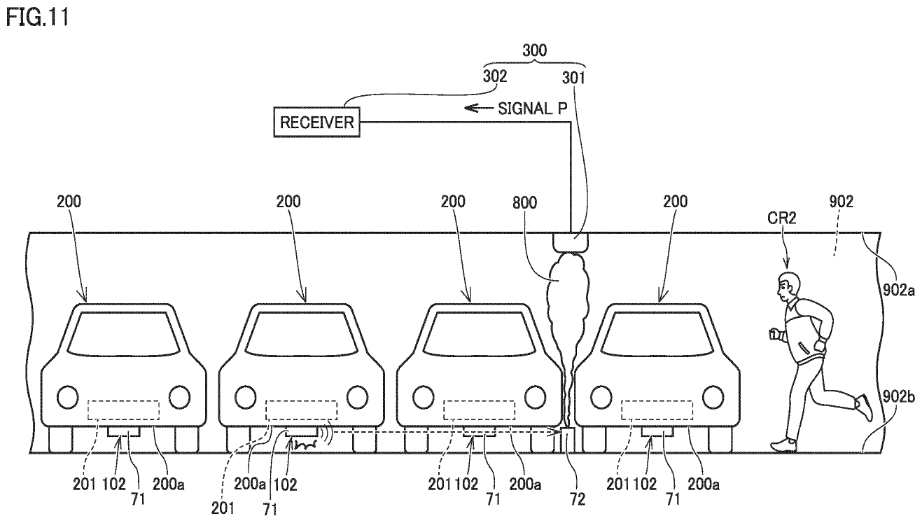

FIG. 9 is a diagram for illustrating a hardware configuration of each of devices constituting a control system according to the second embodiment. FIG. 10 is a flowchart for illustrating a flow of a process performed in the control system shown in FIG. 9. FIG. 11 is a schematic diagram of a cargo compartment for illustrating the state in which an actuation apparatus according to the present embodiment is actuated.

Hereinafter, a control system 102 according to the present embodiment, a fire sign alarm system including control system 102, and a control method will be described with reference to FIGS. 9 to 11. In the present embodiment, control system 102 is used instead of control system 101.

In control system 101 in the first embodiment, various devices are incorporated in one housing 70 as shown in FIG. 4. On the other hand, in control system 102 in the present embodiment, devices are dispersedly incorporated in a first housing 71 and a second housing 72 as shown in FIGS. 9 to 11. Thus, in the present embodiment, control system 102 is constituted of two devices including the first device (the first unit) and the second device (the second unit). In this respect, control system 102 in the present embodiment is different from control system 101 in the first embodiment.

Specifically, in the present embodiment, first housing 71 having a substantially rectangular parallelepiped shape incorporates sensor 10, controller 30, alarm device 40, power supply 50, and a first interface 61 for communication. Second housing 72 having a substantially rectangular parallelepiped shape incorporates actuation apparatus 20, a power supply 50A, and a second interface 62 for communication. First interface 61 and second interface 62 are configured to allow transmission and reception of signals to and from each other through wireless communication. Power supply 50A supplies electric power to actuation apparatus 20 and second interface 62. Note that the communication between first interface 61 and second interface 62 is not limited to wireless communication but may be wired communication.

Similarly to housing 70 in the first embodiment, first housing 71 is disposed in contact with a portion of bottom surface 200a of automobile 200 that is located in the vicinity of (more specifically, directly below) battery 201. Second housing 72 is disposed at a position around detector 301. Specifically, second housing 72 is placed on a portion of floor 902b that is located below detector 301.

As shown in FIG. 10, the flow of the process performed by control system 102 is different from the flow of the process performed by control system 101 in the first embodiment (see FIG. 5) in that steps S11 and S12 are additionally included between steps S3 and S4.

Specifically, when it is determined in step S3 that the surface temperature is equal to or higher than set temperature V1 (YES in step S3), then in step S4, controller 30 actuates alarm device 40 to continuously generate sound and light (typically, a flash of light). Thereby, a notification about the occurrence of an abnormality is provided to the surroundings. After a prescribed time period has elapsed since the start of the actuation of alarm device 40, then in step 11, a control command Q is transmitted to actuation apparatus 20 via first interface 61. In step S12, actuation apparatus 20 receives control command Q via second interface 62.

In step S5, based on reception of control command Q by actuation apparatus 20, actuation apparatus 20 emits smoke 800. Thus, in step S5, according to a remote command, controller 30 actuates actuation apparatus 20 to cause actuation apparatus 20 (specifically, a smoke canister) to emit smoke 800. The process in step S4 may be performed simultaneously with the process in step S5, or may be performed after the process in step S5.

Control system 102 configured as described above also achieves an effect similar to the effect described above in the first embodiment. Therefore, according to control system 102, the risk of occurrence of fire can be reduced by using the existing automatic fire alarm equipment.

In control system 102, smoke 800 from actuation apparatus 20 is emitted below detector 301. Thus, by adopting control system 102, detector 301 can more reliably detect smoke 800 emitted from actuation apparatus 20.

In the example described above in the present embodiment, first housing 71 is disposed in contact with bottom surface 200a of automobile 200, but first housing 71 may be installed in the vicinity of automobile 200 without being in contact with automobile 200, similarly to housing 70A in control system 101A according to the first modification of the first embodiment. In other words, first housing 71 may be placed on a portion of floor 902b of cargo compartment 902 that faces a portion of bottom surface 200a of automobile 200 that is located directly below battery 201.

In the example described above in the present embodiment, controller 30 is incorporated in first housing 71, but controller 30 may be incorporated in second housing 72. In other words, in control system 102, first housing 71 may incorporate sensor 10, power supply 50, and first interface 61, and second housing 72 may incorporate controller 30, actuation apparatus 20, power supply 50A, and second interface 62.

In such a configuration, sensor 10 transmits temperature information R to controller 30 via first interface 61, temperature information R being information indicating the surface temperature of bottom surface 200a that is sensed by sensor 10. When controller 30 receives temperature information R via second interface 62 and determines that the surface temperature indicated by temperature information R is equal to or higher than set temperature V1, controller 30 actuates actuation apparatus 20 to emit smoke 800. Even such a configuration achieves the same effect as that achieved in the configuration in which controller 30 is incorporated in first housing 71.

### Modifications

### First Modification

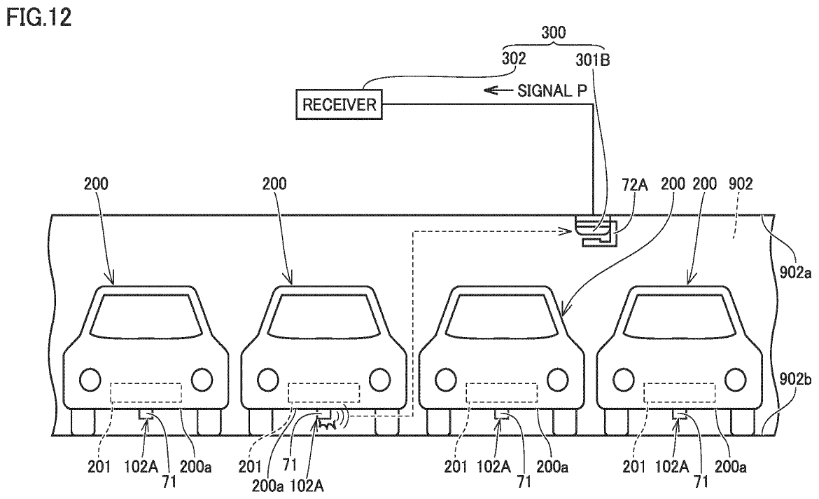

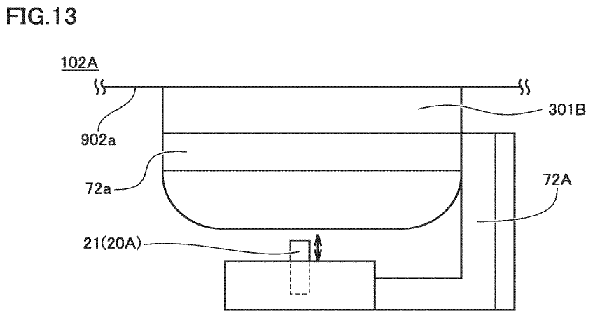

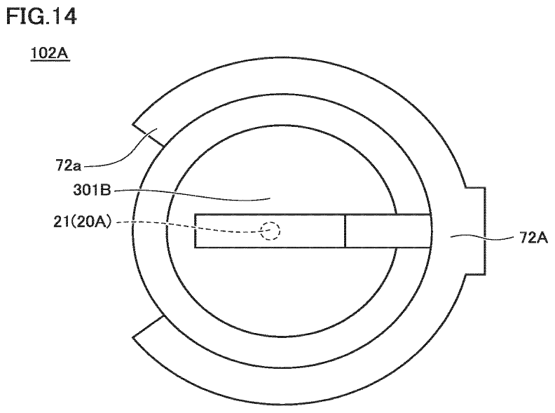

In a configuration which will be described in the present modification, automatic fire alarm equipment 300 includes a detector 301B configured to detect heat instead of detector 301 configured to detect smoke. FIG. 12 is a schematic front view of automobiles to which a control system according to the first modification of the present embodiment is applied. FIG. 13 is a schematic front view of an actuation apparatus according to the present modification. FIG. 14 is a schematic bottom view of the actuation apparatus according to the present modification. Hereinafter, a control system 102A according to the first modification of the second embodiment will be described with reference to FIGS. 12 to 14.

As shown in FIGS. 12 to 14, in the present modification, control system 102A includes a second housing 72A instead of second housing 72. Second housing 72A incorporates an actuation apparatus 20A instead of actuation apparatus 20. In the following example, it is assumed that first housing 71 incorporates controller 30.

Automatic fire alarm equipment 300 includes a plurality of detectors 301B and receiver 302. Specifically, instead of detector 301, detector 301B is provided in cargo compartment 902.

Detector 301B is what is called a differential spot-type detector that is actuated when the internal pressure in an air chamber provided in detector 301B becomes equal to or higher than a set pressure. An air chamber is provided inside the differential spot-type detector. A diaphragm and a contact are provided in the air chamber. In detector 301B, the internal pressure in the air chamber rises, so that the diaphragm is deformed. The diaphragm is deformed to close the contact. When the contact is closed, detector 301B is actuated.

Thus, since the present modification adopts differential spot-type detector 301B, the configuration of the present modification is different from: the configuration adopting detector 301 that detects smoke 800 described in the embodiment; and the configuration adopting ultraviolet spot-type or infrared spot-type detector 301A described in the modification of the first embodiment.

As described above, since detector 301B is different from detector 301, the configuration of actuation apparatus 20A and the arrangement of second housing 72A in control system 102A are different from the configuration of actuation apparatus 20 and the arrangement of second housing 72 in control system 102.

More specifically, in control system 102 according to the above-described second embodiment, actuation apparatus 20 emits smoke 800 as a process for actuating detector 301 (see FIG. 11 and the like), whereas in control system 102A according to the present modification, actuation apparatus 20A applies pressure to the air chamber in detector 301B from outside as a process for actuating detector 301B. Actuation apparatus 20A used in the present modification includes an actuator 21 configured to be able to reciprocate in the upward and downward direction.

Second housing 72A incorporating actuation apparatus 20A and the like has a grip portion 72a formed of a pair of arm-shaped portions. Grip portion 72a serves to grip detector 301B. Thereby, second housing 72A is disposed in contact with detector 301B.

In control system 102A configured as described above, actuation apparatus 20A drives actuator 21 based on reception of control command Q via second interface 62. By driving actuator 21, an outer wall portion of detector 301B in a portion defining the air chamber is pressed by actuator 21. When the outer wall portion is pressed, the internal pressure in the air chamber rises. Specifically, actuation apparatus 20A causes actuator 21 to operate such that the internal pressure in the air chamber becomes equal to or higher than the set pressure. Thereby, detector 301B is actuated. Even in such a configuration, actuation apparatus 20A can actuate detector 301B in the state in which no heat is generated.

Control system 102A configured as described above also achieves an effect similar to the effect described above in each of the first and second embodiments. Therefore, according to control system 102A, the risk of occurrence of fire can be reduced by using the existing automatic fire alarm equipment.

In the example described above in the present modification, actuation apparatus 20A includes actuator 21, but actuation apparatus 20A is not limited to an apparatus including actuator 21. For example, actuation apparatus 20A may include a servomotor and an elastic member such as a spring. In this case, the elastic member can be pressed by the driving force of the servomotor toward the outer wall portion of detector 301B. Alternatively, actuation apparatus 20A may include a gas generator. In this case, by actuating the gas generator directly below detector 301B, the internal pressure in the air chamber can be raised. Alternatively, actuation apparatus 20A may contain gunpowder. In this case, by exploding the gunpowder directly below detector 301B, the internal pressure in the air chamber can be raised.

### Second Modification

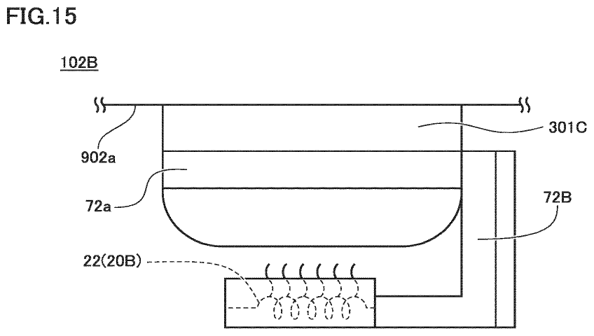

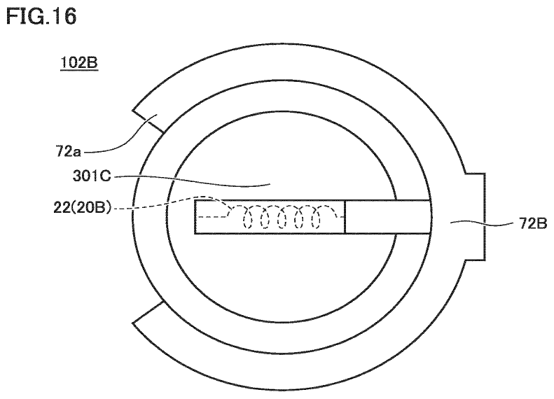

Also in a configuration which will be described in the present modification, automatic fire alarm equipment 300 includes a detector configured to detect heat. FIG. 15 is a schematic front view of an actuation apparatus according to the second modification of the present embodiment. FIG. 16 is a schematic bottom view of the actuation apparatus according to the present modification. Hereinafter, a control system 102B according to the present modification will be described with reference to FIGS. 15 and 16.

As shown in FIGS. 15 and 16, in the present modification, control system 102B includes a second housing 72B instead of second housing 72. Second housing 72B incorporates an actuation apparatus 20B instead of actuation apparatus 20. In the following example, it is assumed that first housing 71 incorporates controller 30.

Automatic fire alarm equipment 300 includes a plurality of detectors 301C and receiver 302. Specifically, instead of detector 301, detector 301C is provided in cargo compartment 902.

Detector 301C is a constant temperature spot-type detector that is actuated when the ambient temperature of detector 301C becomes equal to or higher than a set temperature V2 as the second temperature. The constant temperature spot-type detector includes a heat receiving plate, a circular bimetal, and a contact. In detector 301C, as the temperature of the heat receiving plate rises, the circular bimetal is distorted or inverted. Such distortion or inversion closes the contact. When the contact is closed, the detector is actuated.

Since detector 301C is different from detector 301 as described above, the configuration of actuation apparatus 20B and the arrangement of second housing 72B in control system 102B are different from the configuration of actuation apparatus 20 and the arrangement of second housing 72 in control system 102. Since the arrangement of second housing 72B is the same as that of second housing 72A according to the first modification of the present embodiment, the description thereof will not be repeated.

More specifically, in control system 102 according to the second embodiment, actuation apparatus 20 emits smoke 800 as a process for actuating detector 301 (see FIG. 11 and the like), whereas in control system 102B according to the present modification, actuation apparatus 20B generates heat as a process for actuating detector 301C. More specifically, actuation apparatus 20B includes a nichrome wire 22. Actuation apparatus 20B causes nichrome wire 22 to be red-heated to thereby generate heat sufficient to raise the ambient temperature of detector 301C to be equal to or higher than set temperature V2.

In control system 102B configured as described above, actuation apparatus 20B causes nichrome wire 22 to be red-heated based on reception of control command Q via second interface 62. When the ambient temperature of detector 301C becomes equal to or higher than set temperature V2 by the red-heated nichrome wire 22, the temperature of the heat receiving plate rises. The temperature of the heat receiving plate rises to cause inversion or the like of the circular bimetal. By such inversion or the like, detector 301C is actuated. Even in such a configuration, actuation apparatus 20B can actuate detector 301C in the state in which heat caused by flames is not generated.

Control system 102B configured as described above also achieves an effect similar to the effect described in each of the first and second embodiments. Therefore, according to control system 102B, the risk of occurrence of fire can be reduced by using the existing automatic fire alarm equipment.

In the example described above in the present modification, actuation apparatus 20B includes nichrome wire 22, but actuation apparatus 20B is not limited to an apparatus including nichrome wire 22. For example, actuation apparatus 20B may include a Peltier element or gunpowder. In this case, the Peltier element or the gunpowder generates heat to allow detector 301C to be actuated.

### Third Modification

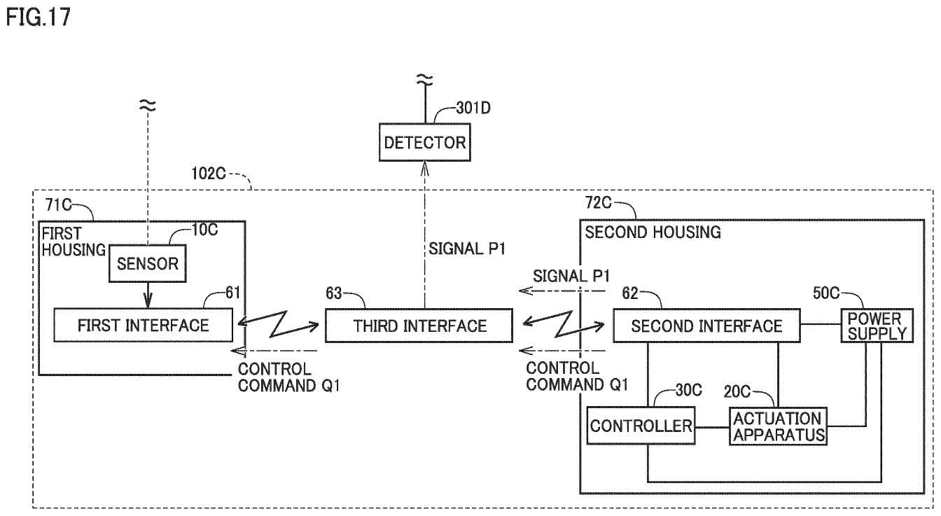

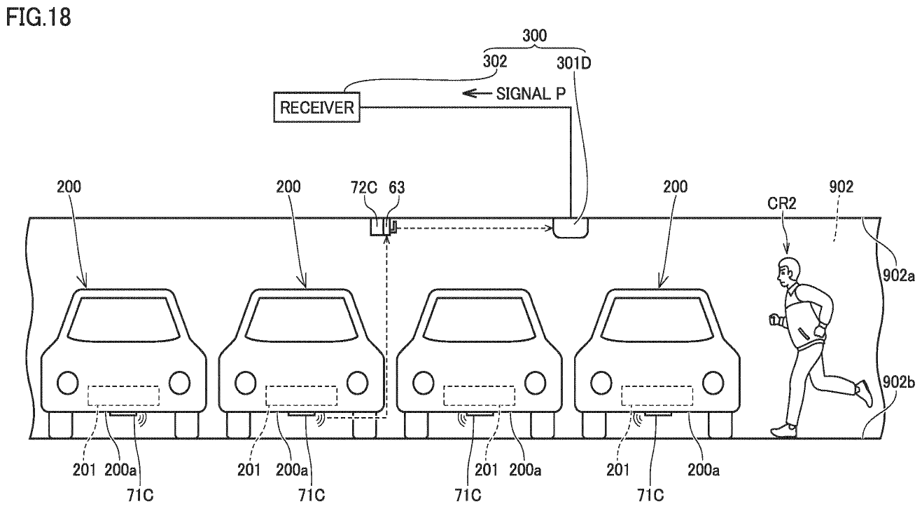

In a configuration which will be described in the present modification, automatic fire alarm equipment 300 includes a detector 301D configured to detect a signal instead of detector 301 configured to detect smoke. FIG. 17 is a diagram for illustrating a hardware configuration of each of devices constituting a control system 102C according to the third modification of the present embodiment. FIG. 18 is a schematic diagram of a cargo compartment for illustrating the state in which an actuation apparatus according to the present modification is actuated. Hereinafter, control system 102C according to the third modification of the second embodiment will be described with reference to FIGS. 17 and 18.

As shown in FIGS. 17 and 18, in the present modification, control system 102C includes a first housing 71C instead of first housing 71. First housing 71C incorporates a sensor 10C and first interface 61. First housing 71C, sensor 10C, and first interface 61 constitute a radio frequency identification (RFID) tag equipped with a temperature sensor.

Sensor 10C corresponds to a portion of the RFID tag that detects a temperature. As sensor 10C, for example, a contact-type temperature sensor is used. First interface 61 corresponds to a portion of the RFID tag that transmits temperature information sensed by sensor 10C as a signal through wireless communication or that receives a control command Q1 transmitted from a controller 30C described later through wireless communication. First housing 71 corresponds to a protection member of the RFID tag that protects sensor 10C and first interface 61.

The RFID tag configured as described above is attached to bottom surface 200a of automobile 200. Thereby, sensor 10C can sense the surface temperature of bottom surface 200a. Note that a plurality of RFID tags may be attached to bottom surface 200a as necessary.

Further, the RFID tag may be installed in the vicinity of a vehicle body of automobile 200, or may be installed in the vicinity of a portion where battery 201 is placed. In consideration of the workability of attachment, the RFID tag is more preferably installed in a lasher that fastens floor 902b of cargo compartment 902 and automobile 200 to each other. In these cases, for example, a contactless-type temperature sensor is preferably used as sensor 10C.

Control system 102C includes a second housing 72C instead of second housing 72. Second housing 72C incorporates an actuation apparatus 20C, controller 30C, a power supply 50C, and second interface 62. Second housing 72C is disposed adjacent to a third interface 63 described later.

Control system 102C further includes third interface 63 for communication. Third interface 63 serves as a relay that relays transmission and reception of a signal between first interface 61 and second interface 62, and relays transmission of a signal from second interface 62 to detector 301D. Third interface 63 is installed, for example, on ceiling 902a of cargo compartment 902. Note that the arrangement of third interface 63 is not particularly limited thereto, but may be installed on a wall or the like of cargo compartment 902, or may be installed on floor 902b of cargo compartment 902.

Automatic fire alarm equipment 300 includes a plurality of detectors 301D and receiver 302. Specifically, instead of detector 301, detector 301D is provided in cargo compartment 902.

Detector 301D is actuated when it receives a predetermined signal. Since detector 301D configured as described above is used, the configuration of actuation apparatus 20C in control system 102C is different from the configuration of actuation apparatus 20 in control system 102.

More specifically, in control system 102 according to the above-described second embodiment, actuation apparatus 20 emits smoke 800 as a process for actuating detector 301 (see FIG. 11 and the like), whereas in control system 102C according to the present modification, actuation apparatus 20C transmits a predetermined signal P1 toward detector 301D as a process for actuating detector 301D. In the present modification, a transmitter configured to be capable of transmitting signal Pl to detector 301D through wireless communication or wired communication is used as actuation apparatus 20C.

In control system 102C configured as described above, controller 30C acquires the temperature information sensed by sensor 10C from this sensor 10C every predetermined first cycle (for example, every 30 seconds). When the surface temperature of bottom surface 200a of automobile 200 that is sensed by sensor 10C becomes equal to or higher than a set temperature V11, controller 30C transmits, to sensor 10C, control command Q1 for changing the first cycle to a predetermined second cycle (for example, every 10 seconds) shorter than the first cycle. Controller 30C subsequently acquires the temperature information sensed by sensor 10C from this sensor 10C every second cycle. Note that set temperature V11 is set at a prescribed temperature lower than set temperature V1 mentioned above.

When the surface temperature of bottom surface 200a of automobile 200 sensed by sensor 10C becomes equal to or higher than set temperature V1, controller 30C causes actuation apparatus 20C to transmit signal P1 to detector 301D. Thereby, detector 301D is actuated.

Control system 102C configured as described above also achieves an effect similar to the effect described above in each of the first and second embodiments.

Therefore, according to control system 102C, the risk of occurrence of fire can be reduced by using the existing automatic fire alarm equipment.

As described above, control system 102 is configured such that, when the state of automobile 200 sensed by sensor 10C satisfies the predetermined condition, controller 30C can change the cycle of acquiring information from sensor 10C from the first cycle to the second cycle shorter than the first cycle. Thereby, the state of automobile 200 can be monitored in a more focused manner in a situation in which there is a relatively high risk of fire occurrence.

In the example described above in the present modification, control system 102C includes third interface 63, but control system 102C does not necessarily have to include third interface 63 as long as direct communication can be established between first interface 61 and second interface 62 and a signal can be directly transmitted from second interface 62 to detector 301D.

### Third Embodiment

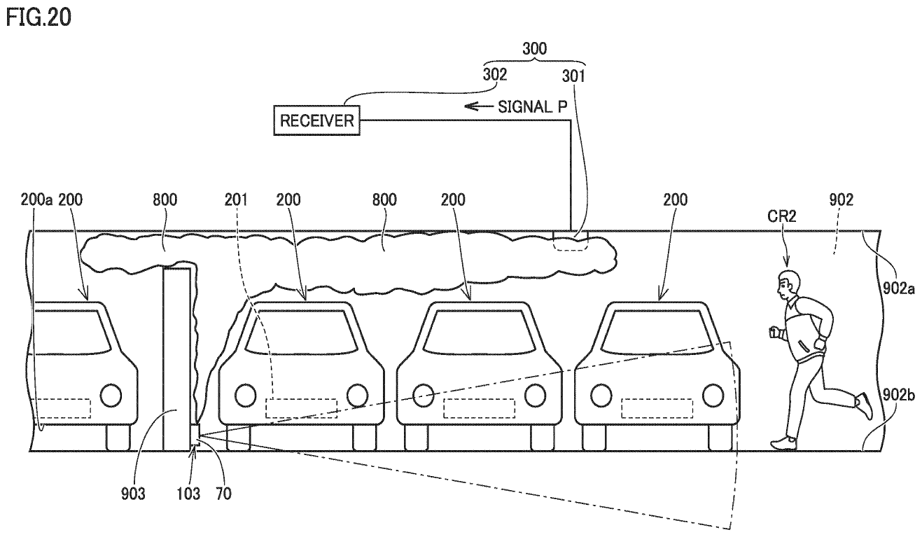

FIG. 19 is a diagram for illustrating a hardware configuration of each of devices constituting a control system according to the third embodiment. FIG. 20 is a schematic diagram of a cargo compartment for illustrating the state in which an actuation apparatus according to the third embodiment is actuated.

Hereinafter, a control system 103 according to the present embodiment, a fire sign alarm system including control system 103, and a control method will be described with reference to FIGS. 19 and 20. In the present embodiment, control system 103 is used instead of control system 101. In the present embodiment, a sensor 13 is used instead of sensor 10.

In control system 101 according to the first embodiment, sensor 10 senses the state of one automobile 200 as shown in FIG. 6. On the other hand, in control system 103 in the present embodiment, sensor 13 is configured to sense the states of a plurality of automobiles 200 as shown in FIGS. 19 and 20. In this respect, control system 103 in the present embodiment is different from control system 101 in the first embodiment.

Specifically, in the present embodiment, housing 70 is disposed in a portion on a surface of a pillar 903 provided in cargo compartment 902, the portion being located relatively close to floor 902b. Note that the position of housing 70 is not particularly limited thereto, but may be disposed on the surface of the wall of cargo compartment 902, or may be disposed on a portion of floor 902b that faces bottom surface 200a of a specific automobile 200.

Sensor 13 incorporated in housing 70 is configured to be capable of sensing the states of the plurality of automobiles 200. Examples of such sensor 13 used in the present embodiment include a contactless multi-lens sensor incorporating a contactless-type temperature sensor.

The contactless multi-lens sensor is mainly configured of an array sensor (for example, a thermopile sensor) constituted of a plurality of contactless-type temperature sensors or a CMOS image sensor, a lens, a lens holder holding the lens, and the like. The contactless-type temperature sensor measures infrared rays emitted from an object to measure the temperature.

By way of example, in the present embodiment, a contactless multi-lens sensor is used that includes an array sensor constituted of a total of 64 contactless-type temperature sensors arranged in eight rows and eight columns. Note that the number and arrangement of the sensors in the contactless multi-lens sensor are not particularly limited thereto but can be changed as appropriate in accordance with the conditions such as a desired viewing angle. As the viewing angle of the contactless multi-lens sensor is larger, the wider range can be measured. Thus, by selecting a sensor having a larger viewing angle, it can be expected to increase the number of automobiles 200 that can be monitored by each of the installed sensors and to enlarge the area to be monitored.

The contactless multi-lens sensor configured as described above is used to allow individual detection of the surface temperatures of automobiles 200 within the field of view corresponding to each of the plurality of contactless-type temperature sensors.

Controller 30 acquires the temperature information indicating the temperature sensed by sensor 13 from sensor 13 every predetermined control cycle T. When the temperatures of the plurality of automobiles 200 sensed by sensor 13 satisfy a predetermined condition, controller 30 causes actuation apparatus 20 to perform a warning process.

Specifically, controller 30 causes actuation apparatus 20 to generate smoke when, among the surface temperatures sensed by sensor 13 at a total of 64 portions on automobile 200, the number of surface temperatures equal to or higher than set temperature V1 becomes equal to or larger than a predetermined number.

Control system 103 configured as described above also achieves an effect similar to the effect described above in the first embodiment. Therefore, according to control system 103, the risk of occurrence of fire can be reduced by using the existing automatic fire alarm equipment.

Further, when control system 103 is configured such that sensor 13 senses the states of the plurality of automobiles 200 as described above, the time and effort required for the operation to install control system 103 can be saved as compared with the case where the sensor senses only the state of one automobile 200.

In the example described above in the present embodiment, controller 30 causes actuation apparatus 20 to generate smoke when the surface temperature of automobile 200 sensed by sensor 13 becomes equal to or higher than set temperature V1, but the present invention is not limited thereto.

By way of example, controller 30 may cause actuation apparatus 20 to generate smoke when a temperature difference between the surface temperature of automobile 200 sensed by sensor 13 and the ambient temperature (more specifically, the atmosphere temperature of cargo compartment 902 loaded with automobiles 200) becomes equal to or higher than a set temperature.

Specifically, the ambient temperature is compared with each of the surface temperatures sensed by sensor 13 at the total of 64 portions on automobile 200. Then, when the number of surface temperatures whose temperature differences from the ambient temperature are equal to or higher than the set temperature becomes equal to or larger than the predetermined number, actuation apparatus 20 may be caused to generate smoke. In this case, control system 103 needs to further include a temperature sensor for measuring the ambient temperature separately from sensor 13. Further, instead of comparing the surface temperature of automobile 200 with the ambient temperature as described above, the surface temperature of automobile 200 may be compared with a predetermined temperature.

As another example, controller 30 may cause actuation apparatus 20 to generate smoke when the amount of change in the surface temperature of automobile 200 sensed by sensor 13 becomes equal to or greater than the predetermined amount of change.

Specifically, controller 30 first acquires the surface temperatures sensed by sensor 13 at a total of 64 portions on automobile 200 at a certain time point, and stores the acquired surface temperatures. The above-mentioned certain time point can be, for example, a time point at which a prescribed time period (e.g., 30 minutes) has elapsed since completion of loading of automobiles 200 on automobile carrier ship 900.

Then, every predetermined control cycle T, controller 30 acquires, from sensor 13, the temperature information indicating the surface temperatures sensed by sensor 13 at the total of 64 portions on automobile 200. Then, controller 30 calculates the amount of change in each of these surface temperatures from each of the surface temperatures at the total of 64 portions on automobile 200 at the above-mentioned certain time point. Actuation apparatus 20 may be caused to generate smoke when, among the amounts of change at 64 portions calculated in this way, the number of amounts of change equal to or greater than the predetermined amount of change becomes equal to or greater than the predetermined number.

### Other Embodiments

The shapes, configurations, sizes, numbers, materials, and the like of the respective portions described above in the embodiments of the present invention and the modifications thereof can be variously modified without departing from the gist of the present invention.

Further, the characteristic configurations described above in the embodiments of the present invention and the modifications thereof can naturally be combined with each other within a range not departing from the gist of the present invention.

Thus, the above-described embodiments and modifications thereof disclosed herein are illustrative and non-restrictive in every respect. The technical scope of the present invention is defined by the terms of the claims and includes any modifications within the scope and meaning equivalent to the terms of the claims.

### Reference Signs List

101, 101A, 101B, 102, 102A, 102B, 103 control system, 10, 10C, 13 sensor, 20, 20A, 20B, 20C actuation apparatus, 21 actuator, 22 nichrome wire, 30, 30C controller, 40 alarm device, 50, 50A, 50C power supply, 61 first interface, 62 second interface, 63 third interface, 70, 70A housing, 71, 71C first housing, 72, 72A, 72B, 72C second housing, 72a grip portion, 200 automobile, 200a bottom surface, 201 battery, 300 automatic fire alarm equipment, 301, 301A, 301B, 301C, 301D detector, 302 receiver, 302a monitor, 302b speaker, 302c operation unit, 800 smoke, 900 automobile carrier ship, 901 steering room, 902 cargo compartment, 902a ceiling, 902b floor, 903 pillar, CR1, CR2 crew member.

1. A control system comprising:
a sensor that senses a state of an article having a possibility of ignition, the sensor being disposed separately from a detector of automatic fire alarm equipment in a space in which the detector is installed;
an actuation apparatus that performs a process for actuating the detector; and
a controller that causes the actuation apparatus to perform the process when the state of the article sensed by the sensor satisfies a condition determined in advance, wherein
the state of the article is at least one of: a temperature of the article; a change in pressure of an internal pressure in the article; a change in intensity of infrared rays generated from the article; a change in intensity of ultraviolet rays generated from the article; and a strain of the article.

2. The control system according to claim 1, wherein
when the state of the article is the temperature of the article, the condition is defined as being equal to or higher than a first temperature determined in advance, and
when the state of the article is one of: the change in pressure of the internal pressure in the article; the change in intensity of the ultraviolet rays generated from the article; the change in intensity of the infrared rays generated from the article; and a change in strain of the article, the condition is defined as being equal to or greater than a first amount of change determined in advance.

3. The control system according to claim 1, wherein
the detector is actuated upon detection of smoke, and
the actuation apparatus generates smoke as the process.

4. The control system according to claim 1, wherein
the detector detects one type of rays of ultraviolet rays and infrared rays,
the detector is actuated when an amount of change in intensity of the one type of rays is equal to or greater than a second amount of change determined in advance, and
the actuation apparatus generates the one type of rays as the process such that the amount of change in intensity of the one type of rays detected by the detector is equal to or greater than the second amount of change.

5. The control system according to claim 1, wherein
the detector has
a first configuration in which the detector is actuated when an internal pressure in the detector is equal to or higher than a pressure determined in advance, or
a second configuration in which the detector is actuated when an ambient temperature of the detector is equal to or higher than a second temperature determined in advance,
when the detector has the first configuration, the actuation apparatus applies pressure to the detector from outside as the process, to raise the internal pressure in the detector to be equal to or higher than the pressure determined in advance, and
when the detector has the second configuration, the actuation apparatus generates heat as the process, to raise the ambient temperature of the detector to be equal to or higher than the second temperature.

6. The control system according to claim 1, wherein
the article is a cargo, and
the space is a cargo compartment.

7. The control system according to claim 6, wherein
the cargo is an automobile incorporating a battery, and
the cargo compartment is provided inside an automobile carrier ship.

8. The control system according to claim 7, wherein the sensor senses a surface temperature of a portion of the automobile, the portion being located in a vicinity of the battery.

9. The control system according to claim 1, further comprising a housing that incorporates the sensor, the actuation apparatus, and the controller, wherein
the housing is disposed in contact with the article or disposed in a vicinity of the article.

10. The control system according to claim 1, further comprising:
a first housing that incorporates the sensor and a first interface for communication, the first housing being disposed in contact with the article or disposed in a vicinity of the article; and
a second housing that incorporates the actuation apparatus and a second interface for communication, the second housing being disposed in contact with the detector or disposed at a position around the detector, wherein
the controller is incorporated in one of the first housing and the second housing,
in a case where the controller is incorporated in the first housing,
the controller transmits a command determined in advance to the actuation apparatus via the first interface when the state of the article sensed by the sensor satisfies the condition, and
the actuation apparatus performs the process based on reception of the command via the second interface, and
in a case where the controller is incorporated in the second housing,
the sensor transmits information indicating the state of the article sensed by the sensor to the controller via the first interface, and
when the controller receives the information via the second interface and the state of the article indicated by the information satisfies the condition, the controller causes the actuation apparatus to perform the process.
